(19) United States
(12) Patent Application Publication
(10) Pub. No.: US 2024/0026074 A1
(43) Pub. Date: Jan. 25, 2024

(54) Polycarbonate Compositions Containing Titanium Dioxide and Glass Flakes Comprising a Titanium Dioxide Coating

(71) Applicant: Covestro Deutschland AG, Leverkusen (DE)

(72) Inventors: Rolf Wehrmann, Krefeld (DE); Anke Boumans, Bedburg-Hau (DE)

(21) Appl. No.: 18/039,031

(22) PCT Filed: Nov. 25, 2021
(86) PCT No.: PCT/EP2021/082976

§ 371 Date: May 26, 2023

(30) Foreign Application Priority Data
Nov. 30, 2020 (EP) 20210659.7

(51) Int. Cl. C08G 64/06; C08K 3/22; C08K 3/40; C08K 9/02

(52) U.S. Cl. CPC C08G 64/06; C08K 3/22; C08K 3/40; C08K 9/02; C08K 2003/2241; C08K 2201/016

(57) ABSTRACT

Described are reflective, titanium dioxide-containing polycarbonate compositions to which 0.001 wt. % to 0.25 wt. % glass flakes including a titanium dioxide coating are added to improve reflectance values, said glass flakes usually being used in larger quantities as effect pigments. Said compositions make it possible to produce brilliant white molded parts.

### CROSS-REFERENCE TO RELATED APPLICATIONS

This application is the United States national phase of International Application No. PCT/EP2021/082976 filed Nov. 25, 2021, and claims priority to European Patent Application No. 20210659.7 filed Nov. 30, 2020, the disclosures of which are hereby incorporated by reference in their entireties.

### BACKGROUND OF THE INVENTION

### Field of the Invention

The present invention provides titanium dioxide-containing polycarbonate-based compositions having high reflectance. The invention further relates to improving the reflectance of titanium dioxide-containing compositions. The present invention further relates to molded parts composed of these compositions, for instance for housings/housing parts or other elements in the electricals and electronics and IT sectors, for example for trim pieces and switches for automotive interior illumination and in particular for reflectors of illumination units such as LED lamps or LED arrays and automotive headlights and taillights or indicators.

### Description of Related Art

It is known from the prior art to add titanium dioxide to plastics such as polycarbonate to improve reflectance.

CN 109867941 A for instance describes a reflective polycarbonate material containing titanium dioxide, a liquid silicone and further polymeric constituents.

TW 200743656 A discloses flame-retardant, halogen-free, reflective polycarbonate compositions which, in addition to titanium dioxide, contain inorganic fillers such as clay or silica and further organic components such as optical brighteners, perfluoroalkylene compounds and metal salts of aromatic sulfur compounds.

The reflectance values achieved with conventional compositions are increasingly failing to meet market expectations. For components such as reflectors for example there is a demand for compositions having ever higher reflectance to utilize the employed energy as well as possible.

However, large amounts of titanium dioxide are required to achieve high reflectance values. This is disadvantageous since titanium dioxide can lead to decomposition of the polycarbonate matrix, thus potentially leading to melt instabilities and a reduction in the viscosity of the compound, as a result of which thermal and mechanical properties are also impaired.

The amount of titanium dioxide also has a marked effect on the cost of the polycarbonate compositions and it is therefore desirable to increase reflectance through measures other than addition of ever greater amounts of titanium dioxide.

Optical brighteners that could be added in turn have the disadvantage that their use results in a nonlinear reflectance curve which can lead to a blue tint of the material which is considered disruptive.

### SUMMARY OF THE INVENTION

It is accordingly an object of the present invention to provide titanium dioxide-containing, polycarbonate-based compositions having improved reflectance and corresponding molded parts made of these compositions, wherein in addition to improved reflectance the compositions preferably should not exhibit significantly poorer flow behavior during processing and/or should also lack disruptive tints.

It has surprisingly been found that titanium dioxide-containing compositions based on polycarbonate exhibit elevated reflectances when they contain a very low concentration of glass flakes comprising a titanium dioxide coating. Even amounts of 0.5% by weight lead to a noticeable deterioration in reflectance. In addition, depending on the employed glass flakes, marked glittering, shine effects or metallic-appearance surfaces are already observable. Such glass flakes are otherwise typically employed in amounts of several percent by weight to be able to function as an effect pigment in transparent or opaque plastics. Other customary applications of glass flakes may be found in the cosmetics industry, for example in lipstick, eyeliner or powder. They are also employed as effect pigments as a constituent of printing inks in the coating of bottles or cans.

When used in polycarbonate compositions containing titanium dioxide as a white pigments it is important for the glass flakes to have a low intrinsic color and to be compatible with the polycarbonate matrix. An excessively high intrinsic color leads to in an increase in the yellowness index and thus to a reduction in reflectance. If there is a lack of compatibility with the polycarbonate matrix this leads to polymer decomposition during compounding and during thermoplastic processing such as injection molding or extrusion, which is likewise associated with an undesired increase in yellowness index and a change in rheological properties. The thermal and mechanical properties of the components also deteriorate.

According to the invention surprising enhancement of reflectance is achieved using a very low concentration of glass flakes comprising a titanium dioxide coating of 0.001% to 0.25% by weight, preferably 0.004% to 0.2% by weight, more preferably 0.004% to 0.1% by weight, particularly preferably 0.006% to 0.010% by weight. The concentration of the glass flakes comprising a titanium dioxide coating is sufficiently low to ensure that their character of acting as an effect pigment does not become visually apparent and the brilliant white color impression of the injection molded articles is retained unaltered. The flow behavior of the compositions is not significantly affected and the good processability in injection molding is retained.

### DETAILED DESCRIPTION

Thermoplastic compositions according to the invention are therefore those comprising
A) 44% by weight to 96.999% by weight of aromatic polycarbonate,
B) 3.0% to 30.0% by weight of titanium dioxide and
C) glass flakes comprising a titanium dioxide coating,
   characterized in that
   the amount of component C is 0.001% by weight to 0.25% by weight,
   wherein the reported amounts are in each case based on the total weight of the thermoplastic composition.

The reported % by weight values below are also in each case based on the total weight of the respective thermoplastic composition unless otherwise stated.

Thermoplastic compositions preferred according to the invention contain
A) 44.8% by weight to 95.996% by weight of aromatic polycarbonate,
B) 4.0% to 25% by weight of titanium dioxide and
C) 0.004% by weight to 0.2% by weight of glass flakes comprising a titanium dioxide coating,
   wherein the reported amounts are in each case based on the total weight of the thermoplastic composition.

The compositions according to the invention may in principle also contain one or more blend partners.

Examples of thermoplastic polymers suitable as blend partners are polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates, poly- or copolymethacrylate, for example poly- or copolymethylmethacrylates (such as PMMA), and also copolymers with styrene, for example transparent polystyrene-acrylonitrile (PSAN), thermoplastic polyurethanes and/or polymers based on cyclic olefins (e.g. TOPAS®, a commercial product from Ticona).

More preferred thermoplastic compositions consist of
A) 44.8% by weight to 95.996% by weight of aromatic polycarbonate,
B) 4.0% to 25% by weight of titanium dioxide and
C) 0.004% by weight to 0.2% by weight of glass flakes comprising a titanium dioxide coating,
D) 0% to 30% by weight of one or more further additives(s) distinct from components B and C,
E) optionally one or more blend partners,
   wherein the reported amounts are in each case based on the total weight of the thermoplastic composition.

Yet more preferred thermoplastic compositions consist of
A) 44.8% by weight to 95.996% by weight of aromatic polycarbonate,
B) 4.0% to 25% by weight of titanium dioxide and
C) 0.004% by weight to 0.2% by weight of glass flakes comprising a titanium dioxide coating,
D) 0% to 30% by weight of one or more further additives(s) distinct from components B and C,
   wherein the reported amounts are in each case based on the total weight of the thermoplastic composition.

Thermoplastic compositions particularly preferred according to the invention consist of
A) 64.8% by weight to 95.996% by weight of aromatic polycarbonate,
B) 4.0% to 25% by weight of titanium dioxide and
C) 0.004% by weight to 0.2% by weight of glass flakes comprising a titanium dioxide coating,
D) 0% to 10% by weight of one or more further additives(s) distinct from components B and C,
   wherein the reported amounts are in each case based on the total weight of the thermoplastic composition.

Thermoplastic compositions very particularly preferred according to the invention consist of
A) 76.99% by weight to 94.994% by weight, in particular 76.99% by weight to 94.993% by weight, of aromatic polycarbonate,

B) 5% to 20% by weight of titanium dioxide and
C) 0.006% by weight to 0.010% by weight of glass flakes comprising a titanium dioxide coating,
D) 0% to 3% by weight, in particular 0.01% to 3% by weight, of one or more further additive(s) distinct from components B and C,
   wherein the reported amounts are in each case based on the total weight of the thermoplastic composition.

In the context of the present invention—unless explicitly stated otherwise—the stated % by weight values for components A, B, C and optionally D are in case based on the total weight of the composition. It will be appreciated that all of the components present in the composition according to the invention, i.e. the amounts of the components A, B, C, optionally D, optionally further components, sum to 100% by weight. In addition to the components A, B, C, optionally D, the composition may in principle contain further components provided the abovementioned core properties of the compositions according to the invention are retained. The compositions may accordingly contain one or more further thermoplastics not covered by any of the components A to D as blend partners (component E). However, it is very particularly preferable when the above-described compositions contain no further components but rather the amounts of the components A, B, C and optionally D, especially in the described preferred embodiments, sum to 100% by weight, i.e. the compositions consist of the components A, B, C, optionally D. It will further be appreciated that the titanium dioxide of component B will be considered separately to the titanium dioxide coating of the glass flakes. The titanium dioxide of the coating of the glass flakes is not captured by the quantitative range of component B.

It will be appreciated that the employed components may contain typical impurities arising from their production processes for example. It is preferable to use the purest possible components. It will further be appreciated that these impurities may also be present in the event of an exhaustive formulation of the composition. The impurities are part of the total weight of the respective component.

The present invention also provides for improving the reflectance, preferably determined according to ASTM E 1331-2015 at a layer thickness of 2 mm, of titanium dioxide-containing polycarbonate compositions through addition of glass flakes comprising a titanium dioxide coating. The improvement in reflectance relates to the corresponding compositions without glass flakes comprising a titanium dioxide coating. “Improving reflectance” is to be understood as meaning any increase in the reflectance value whatsoever. The improvement in reflectance is preferably achieved while retaining the flowability and shine of the reference composition. The material especially preferably does not have a glittering or metallic-appearing surface.

The compositions whose reflectance is further improved through addition of component C have a reflectance before addition of component C of at least 95%, more preferably 95.5%, determined according to ASTM E 1331-2015 at a thickness 2 mm.

It will be appreciated that the features recited as preferred etc. for the composition according to the invention also apply in respect of the use according to the invention. It is therefore preferably to use especially 0.006% to 0.10% by weight of the glass flakes to improve reflectance.

The individual constituents of the compositions according to the invention are more particularly elucidated hereinbelow:

### Component A

“Aromatic polycarbonate” or just “polycarbonate” in the context of the present invention is to be understood as meaning both aromatic homopolycarbonates and aromatic copolycarbonates. These polycarbonates may be linear or branched in the familiar manner According to the invention, it is also possible to use mixtures of polycarbonates.

Compositions according to the invention contain as component A at least 44% by weight, preferably at least 44.8% by weight, more preferably at least 64.8% by weight, yet more preferably at least 76.99% by weight, of aromatic polycarbonate. According to the invention a proportion of at least 44% by weight, preferably at least 64.8% by weight, of aromatic polycarbonate in the total composition means that the composition is based on aromatic polycarbonate. A single polycarbonate or a mixture of two or more polycarbonates may be present.

The polycarbonates present in the compositions are produced in a known manner from dihydroxyaryl compounds, carbonic acid derivatives, and optionally chain terminators and branching agents.

Details of the production of polycarbonates have been set out in many patent specifications over the past 40 years or so. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Muller, H. Nouvertné, BAYER AG, “Polycarbonates” in Encyclopedia of Polymer Science and Engineering, Volume 11, Second Edition, 1988, pages 648-718, and lastly to U. Grigo, K. Kirchner and P. R. Müller “Polycarbonate” [Polycarbonates] in Becker/Braun, Kunststoff-Handbuch [Plastics Handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117 to 299.

Aromatic polycarbonates are produced, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diiso-propylbenzene and 1,1-bis(4-hydroxyphenyl)-3,3,5-trimethylcyclohexane and also the bisphenols (I) to (III)

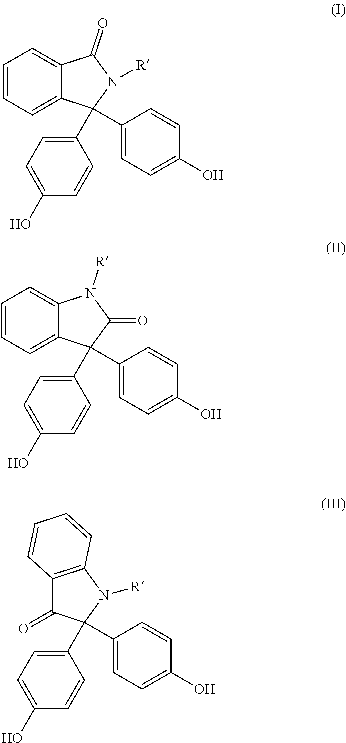

in which each R′ is C₁- to C₄-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,365 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are phenols which are mono or polysubstituted with linear or branched, preferably unsubstituted C₁ to C₃₀ alkyl radicals or with tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxy-phenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and/or (III)

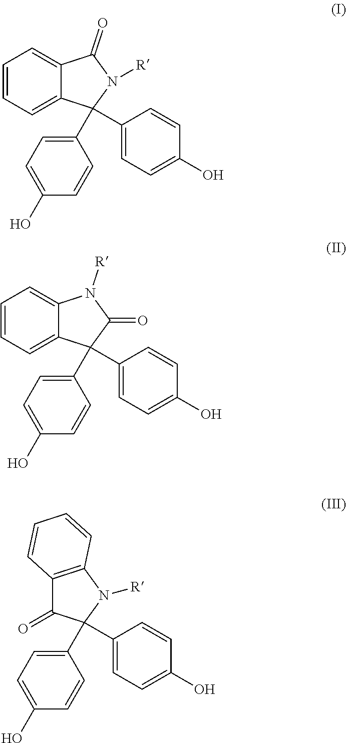

in which each R′ is C₁- to C₄ -alkyl, aralkyl or aryl, preferably methyl or phenyl, very particularly preferably methyl,
   in particular with bisphenol A.

Also preferred are copolycarbonates produced using diphenols of general formula (1a):

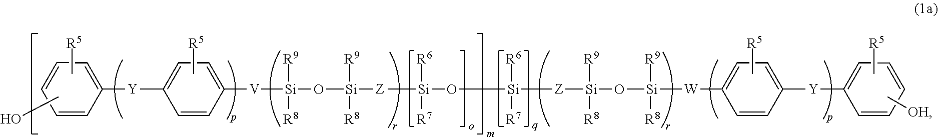

wherein
R⁵ represents hydrogen or C₁- to C₄-alkyl, C₁- to C₃-alkoxy, preferably hydrogen, methoxy or methyl,
R⁶, R⁷, R⁸ and R⁹ each independently of one another represent C₁-C₄-alkyl or C₆-C₁₂-aryl, preferably methyl or phenyl,
Y represents a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or represents a C₅- to C₆-cycloalkylidene radical which may be mono- or polysubstituted with C₁-bis C₄-alkyl, preferably represents a single bond, —O—, isopropylidene or a C₅- to C₆-cycloalkylidene radical which may be mono- or polysubstituted with C₁- to C₄-alkyl,
V represents oxygen, C₂- to C₆-alkylene or C₃- to C₆-alkylidene, preferably oxygen or C₃-alkylene,
p, q and r are each independently 0 or 1,
when q=0, W represents a single bond, when q=1 and r=0, W represents oxygen, C₂- to C₆-alkylene or C₃- to C₆-alkylidene, preferably oxygen or C₃-alkylene,
when q=1 and r=1, W and V each independently represent C₂- to C₆-alkylene or C₃- to C₆-alkylidene, preferably C₃-alkylene,
Z represents a C₁- to C₆-alkylene, preferably C₂-alkylene,
represents an average number of repeating units from 10 to 500, preferably 10 to 100, and
m is an average number of repeat units from 1 to 10, preferably 1 to 6, more preferably 1.5 to 5. It is likewise possible to use to the diphenols in which two or more siloxane blocks of general formula (1a) are bonded to one another via terephthalic acid and/or isophthalic acid to form ester groups.

Especial preference is given to (poly)siloxanes of formulae (2) and (3)

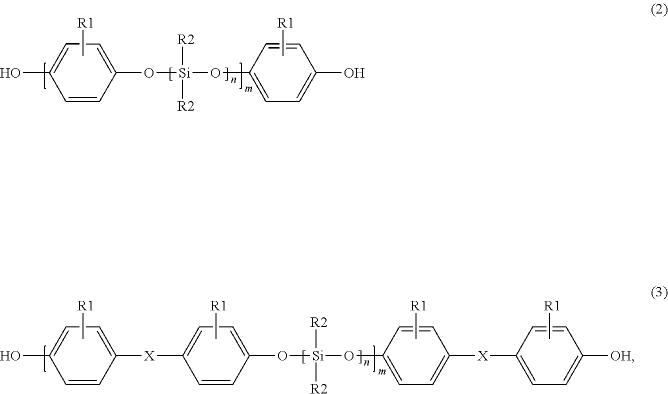

wherein R1 represents hydrogen, C₁- to C₄-alkyl, preferably hydrogen or methyl and especially preferably hydrogen,
R2 independently at each occurrence represents aryl or alkyl, preferably methyl,
X represents a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably represents a single bond, C₁- to C₅-alkylene, C₂- to C₅-alkylidene, C₅- bis C₁₂-cycloalkylidene, —O—, —SO— —CO—, —S—, —SO₂—, particularly preferably a single bond, isopropylidene, C₅- to C₁₂-cycloalkylidene or oxygen and very particularly preferably isopropylidene,
n represents an average number from 10 to 400, preferably 10 to 100, especially preferably 15 to 50 and
m represents an average number from 1 to 10, preferably from 1 to 6 and especially preferably from 1.5 to 5.

The siloxane block may similarly preferably be derived from the following structure

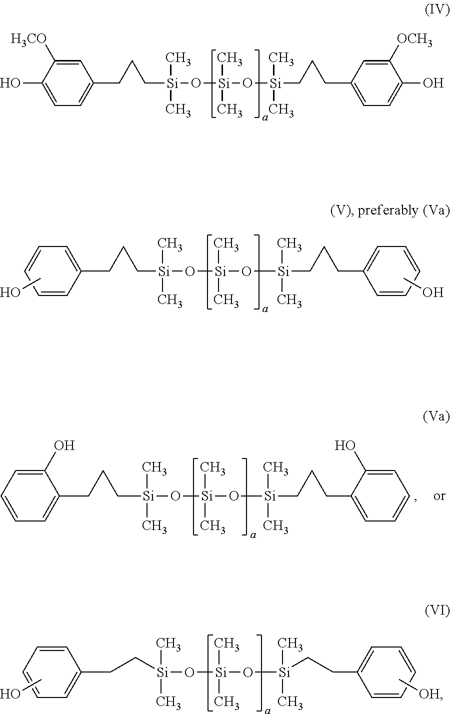

wherein a in formulae (IV), (V) and (VI) represents an average number of 10 to 400, preferably 10 to 100 and particularly preferably 15 to 50.

It is likewise preferable when at least two identical or different siloxane blocks of general formulae (IV), (V) or (VI) are bonded to one another via terephthalic acid and/or isophthalic acid to form ester groups.

It is likewise preferable when in formula (1a) p=0 is, V represents C₃-alkylene, r=1, Z represents C₂-alkylene, R⁸ and R⁹ represent methyl, q=1 is, W represents C₃-alkylene, m=1 is, R⁵ represents hydrogen or C₁- to C₄-alkyl, preferably hydrogen or methyl, R⁶ and R⁷ each independently of one another represent C₁- to C₄-alkyl, preferably methyl, and o is 10 to 500.

Copolycarbonates having monomer units of formula (IV) and in particular also the production thereof are described in WO 2015/052106 A2.

The thermoplastic polycarbonates, including the thermoplastic aromatic polyester carbonates, preferably have weight-average molecular weights M_{w} of 15 000 to 40 000 g/mol, more preferably to 34 000 g/mol, particularly preferably of 17 000 to 33 000 g/mol, in particular of 19 000 to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm Particle sizes of column material: 3 μm to 20 μm. Concentration of solutions: 0.2% by weight. Flow rate: 1.0 ml/min, temperature of solutions: 30+ C. Use of UV and/or RI detection.

To achieve incorporation of additives, component A is preferably employed in the form of powders, pellets or mixtures of powders and pellets.

### Component B

Compositions according to the invention contain 3.0% by weight to 30.0% by weight, preferably 4.0% by weight to 25% by weight, particularly preferably 5% by weight to 20% by weight, very particularly preferably 5.0% to 20.0% by weight, in particular 5.0% to 15% by weight, most preferably 10 to 13% by weight, of titanium dioxide.

The titanium dioxide of component B does not comprise titanium dioxide used as a coating on the glass flakes.

The titanium dioxide of component B of the compositions according to the invention preferably has an average particle size D₅₀, determined by scanning electron microscopy (STEM), of 0.1 to 5 μm, preferably 0.2 μm to 0.5 μm. However, the titanium dioxide may also have a different particle size, for example an average particle size D₅₀, determined by scanning electron microscopy (STEM), of ≥0.5 μm, for instance 0.65 to 1.15 μm.

The titanium dioxide preferably has a rutile structure.

The titanium dioxide used in accordance with the invention is a white pigment, Ti(IV)O₂. Colored titanium dioxides contain not only titanium but also elements such as Sb, Ni, Cr in significant amounts, so as to result in a color impression other than “white”. It will be appreciated that traces of other elements may also be present as impurities in the titanium dioxide white pigment. However, these amounts are so small that the titanium dioxide does not take on any tint as a result.

Suitable titanium dioxides are preferably those produced by the chloride process, hydrophobized, specially aftertreated and suitable for use in polycarbonate. Instead of sized titanium dioxide, compositions according to the invention may in principle also employ unsized titanium dioxide or a mixture of both. However, the use of sized titanium dioxide is preferred.

Possible surface modifications of titanium dioxide include inorganic and organic modifications. These include for example aluminum- or polysiloxane-based surface modifications. An inorganic coating may contain 0.0% to 5.0% by weight of silicon dioxide and/or aluminum oxide. An organic-based modification may contain 0.0% by weight to 3.0% by weight of a hydrophobic wetting agent. The titanium dioxide preferably has an oil absorption number determined according to DIN EN ISO 787-5:1995-10, of 12 to 18 g/100 g of titanium dioxide, more preferably of 13 to 17 g/100 g of titanium dioxide, particularly preferably of 13.5 to 15.5 g/100 g of titanium dioxide.

Particular preference is given to titanium dioxide having the standard designation R2 according to DIN EN ISO 591-1:2001-08, which is stabilized with aluminum and/or silicon compounds and has a titanium dioxide content of at least 96.0% by weight. Such titanium dioxides are available under the brand names Kronos 2233 and Kronos 2230.

### Component C

Component C of the compositions according to the invention is glass flakes comprising a titanium dioxide coating. “Glass flakes comprising a titanium dioxide coating” is to be understood as meaning that the titanium dioxide coating is regarded as part of the glass flakes, i.e. unless otherwise stated explicitly, the size specifications refer to the particles of component C in their entirety, i.e. to the glass cores together with their titanium dioxide coating. The employed glass flakes are shard-shaped and are much smaller in thickness than in length. The glass flakes preferably have surface that is as smooth as possible.

The coating could in principle be carried out on the basis of various oxides, including on the basis of various iron oxide such as Fe₂O₃ or Fe₃O₄, though these have an intense intrinsic color and are thus unsuitable for high-reflectance white compounds. Only titanium dioxide coating of the glass flakes is used for such applications.

The glass flakes—based purely on the glass, without a titanium dioxide coating—contain preferably 59% by weight to 65% by weight of SiO₂, 8% by weight to 15% by weight of Al₂O₃, 20% by weight to 30% by weight of calcium oxide CaO and 1% by weight to 5% by weight of magnesium oxide MgO. The glass composition is preferably free from boric acid and other borates and also free from zinc compounds. It more preferably contains >0% to less than 2% by weight of lithium oxide, sodium oxide and potassium oxide and also 0% to 5% by weight of titanium oxide. It is yet more preferable when essentially no barium oxide, strontium oxide and zirconium oxide are present either. Very particularly preference is given 47% by weight ≤SiO₂—Al₂O₃≤57% by weight. Suitable glass flakes and their production are described in particular in EP 1829833 A1.

The surfaces of the glass cores are coated with one or more metal oxides, wherein titanium dioxide is part of the coating. It will be appreciated that component C in a thermoplastic composition according to the invention may also be a mixture of one or more types of glass flakes comprising a titanium dioxide coating.

Rutile-type titanium dioxide is particularly preferred. The thickness of the TiO₂ coating is preferably thin enough to ensure that the most neutral possible white is reflected.

Particle size distributions of the glass flakes may be determined using scanning electron microscopy (SEM). The evaluation includes calculating the equivalent circle diameter (ECD). The equivalence refers to the area of a particle projected onto a base. The ECD value is the diameter of a circle having an area equal to the area of the particle. The ECD of the individual glass flakes is preferably between 0.5 μm and 250 μm, more preferably between 1 μm and 200 μm, particularly preferably between 20 μm and 175 μm, very particularly preferably between 30 μm and 150 μm. The average ECD (D50 value, determined by scanning electron microscopy (STEM)) is preferably between 5 μm and 25 μm. The aspect ratio (length:width) is preferably between 1 and 5, more preferably between 1.5 and 4, particularly preferably between 2 and 3.

The thickness of the glass flakes comprising a titanium dioxide coating determined by scanning electron microscopy is preferably in the range from 0.3 μm to 12 μm, more preferably from 0.4 μm to 10 μm, yet more from 0.5 μm to 6 μm, particularly preferably between 1 μm and 3 μm, very particularly preferably between 1.0 and 2.0 μm.

The thickness of the titanium dioxide coating of the glass flakes may be determined using electron microscopy in conjunction with energy-dispersive X-ray spectrometry. The glass flakes are homogeneously coated with titanium dioxide. “Homogeneously” is presently to be understood as meaning that the coating has approximately the same thickness over the surface surface of the glass, wherein “approximately” is preferably to be understood as meaning a maximum deviation at an individual point of ±20%, more preferably ±10%, yet more preferably ±5% from the average thickness of the surface coating. The thickness of the coating is preferably between 50 nm and 400 nm, preferably between 80 nm and 350 nm and particularly preferably between 100 nm and 300 nm, very particularly preferably between 120 nm and 200 nm.

The proportion of the glass flakes comprising a titanium dioxide coating in the total polycarbonate-based composition is 0.001% by weight to 0.25% by weight, preferably 0.001% by weight to 0.15% by weight, more preferably 0.004% to 0.1% by weight, yet more preferably 0.004% by weight to 0.10% by weight, particularly preferably 0.005% to 0.02% by weight, very particularly preferably 0.006% by weight to by weight.

### Component D

Optionally also present in addition are further additives preferably in amounts of up to 30% by weight, more preferably up to 10.0% by weight, yet more preferably 0.01% by weight to 6.0% by weight, particularly preferably 0.1% by weight to 3.0% by weight, very particularly preferably 0.2% by weight to 1.0% by weight, in particular up to 0.5% by weight of other customary additives (“further additives”). The group of further additives does not include titanium dioxide since this has been described above as component B. The group of further additives likewise does not include glass flakes comprising a titanium dioxide coating of component C.

Such further additives, such as are typically added to polycarbonates, include in particular heat stabilizers, flame retardants, antioxidants, mold release agents, anti-drip agents, for instance polytetrafluoroethylene (Teflon) or SAN-encapsulated PTFE (e.g. Blendex 449), UV absorbers, IR absorbers, impact modifiers, antistats, optical brighteners, fillers distinct from components B and C, for example talc, quartz, light scattering agents, hydrolysis stabilizers, compatibilizers, inorganic pigments and/or additives for laser marking that are distinct from component B, especially in the amounts customary for polycarbonate-based compositions. Such additives are described for example in EP-A 0 839 623 , WO-A 96/15102, EP-A 0 500 496 or in “Plastics Additives Handbook”, Hans Zweifel, 5th Edition 2000, Hanser Verlag, Munich. These additives may be added individually or else as mixtures. It will be appreciated that it is only permissible to add such additives in such amounts that do not have a significant adverse impact on the inventive effect of improved reflectance. Carbon black, for example, is preferably not included. An improvement in reflectance relative to corresponding reference compositions that differ from the composition according to the invention only in that they do not contain any glass flakes of component C must also be observed.

The additives are preferably selected from the group consisting of heat stabilizers, flame retardants, antioxidants, mold release agents, anti-drip agents, UV absorbers, IR absorbers, impact modifiers, antistats, optical brighteners, fillers distinct from components B and C, light scattering agents, hydrolysis stabilizers, transesterification inhibitors, compatibilizers and/or additives for laser marking If additives are present one or more of these additives may represent component D in a composition according to the invention.

The further additives are particularly preferably those selected from the group consisting of flame retardants, anti-drip agents, UV absorbers, heat stabilizers, antioxidants, antistats, mold release agents, impact modifiers, transesterification inhibitors.

The compositions more preferably contain at least one flame retardant selected from the group of alkali metal, alkaline earth metal or ammonium salts of aliphatic/aromatic sulfonic acid, sulfonamide and sulfonimide derivatives or else combinations thereof.

According to the invention, “derivatives” is here and elsewhere to be understood as meaning compounds where the molecular structure has a different atom or a different group of atoms in place of

an H-atom or a functional group or where one or more
atoms/group of atoms have been removed. The parent compound thus remains recognizable.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany.

The amounts of alkali metal, alkaline earth metal and/or ammonium salts of aliphatic/aromatic sulfonic acid, sulfonamide and sulfonimide derivatives in the composition, if employed, preferably sum to 0.05% by weight to 0.5% by weight, more preferably 0.06% by weight to 0.3% by weight, particularly preferably by weight to 0.2% by weight, particularly preferably 0.065% by weight to 0.12% by weight.

Additionally or alternatively present preferred additives are heat stabilizers.

Suitable heat stabilizers are in particular phosphorus-based stabilizers selected from the group of the phosphates, phosphites, phosphonites, phosphines and mixtures thereof. It is also possible to use mixtures of different compounds from one of these subgroups, for example two phosphites.

Heat stabilizers preferably used are phosphorus compounds having the oxidation number +III, in particular phosphines and/or phosphites.

Particularly preferably suitable heat stabilizers are triphenylphosphine, tris(2,4-di-tert-butylphenyl) phosphite (Irgafos® 168), tetrakis(2,4-di-tert-butylphenyl)-[1,1-biphenyl]-4,4′-diylbisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36).

They may be employed alone or in admixture, for example Irganox® B900 (mixture of Irgafos® 168 and Irganox® 1076 in a 4:1 ratio) or Doverphos® S-9228 with Irganox® B900/Irganox® 1076.

The heat stabilizers are preferably employed in amounts of up to 1.0% by weight, more preferably 0.003% by weight to 1.0% by weight, yet more preferably 0.005% to 0.5% by weight, particularly preferably 0.01% to 0.2% by weight.

Preferred additives also include specific UV stabilizers having a lowest possible transmittance below 400 nm and a highest possible transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin ® 234, BASF SE, Ludwigshafen), 2-(2′-hydroxy-5′-(tert-octyl)phenyl)benzotriazole (Tinuvin ® 329, BASF SE, Ludwigshafen), bis(3-(2H-benzotriazolyl)-2-hydroxy-5-tert-octyl)methane (Tinuvin ® 360, BASF SE, Ludwigshafen), 2-(4,6-diphenyl-1,3,5-triazin-2-yl)-5-(hexyloxy)phenol (Tinuvin ® 1577, BASF SE, Ludwigshafen), 2-(5-chloro-2H-benzotriazol-2-yl)-6-(1,1-dimethylethyl)-4-methylphenol (Tinuvin ® 326, BASF SE, Ludwigshafen), and also benzophenones such as 2,4-dihydroxybenzophenone (Chimassorb ® 22, BASF SE, Ludwigshafen) and 2-hydroxy-4-(octyloxy)benzophenone (Chimassorb ® 81, BASF SE, Ludwigshafen), 2,2-bis[[(2-cyano-1-oxo-3,3-diphenyl-2-propenyl)oxy]methyl]-1,3-propanediyl ester (9CI) (Uvinul 3030, BASF SE Ludwigshafen), 2-[2-hydroxy-4-(2-ethylhexyl)oxy]phenyl-4,6-di(4-phenyl)phenyl-1,3,5-triazine (Tinuvin 1600, BASF SE, Ludwigshafen), tetraethyl 2,2′-(1,4-phenylenedimethylidene)bismalonate (Hostavin B-Cap, Clariant AG) or N-(2-ethoxy-phenyl)-N′-(2-ethylphenyl)ethanediamide (Tinuvin 312, CAS no. 23949-66-8, BASF SE, Ludwigshafen).

Particularly preferred specific UV stabilizers are Tinuvin 360, Tinuvin 329, Tinuvin 326, Tinuvin 1600, Tinuvin 312, Uvinul 3030 and/or Hostavin B-Cap, very particularly preferably Tinuvin 329 and Tinuvin 360.

It is also possible to use mixtures of the abovementioned ultraviolet absorbers.

If UV absorbers are present, the composition preferably contains ultraviolet absorbers in an amount of up to 0.8% by weight, preferably 0.05% by weight to 0.5% by weight, more preferably 0.08% by weight to 0.4% by weight, very particularly preferably 0.1% by weight 0.35% by weight, based on the overall composition.

The compositions according to the invention may also comprise phosphates or sulphonate esters as transesterification inhibitors. A preferably present transesterification inhibitor is triisooctyl phosphate. Triisooctyl phosphate is preferably used in amounts of 0.003% by weight to 0.05% by weight, more preferably 0.005% by weight to 0.04% by weight and particularly preferably of 0.01% by weight to 0.03% by weight, based on the total composition.

Examples of impact modifiers suitable as additives include: acrylate core-shell systems such as ABS or MBS or butadiene rubbers (Paraloid series from DOW Chemical Company); olefin-acrylate copolymers, for example the Elvaloy® series from DuPont; silicone acrylate rubbers, for example the Metablen® series from Mitsubishi Rayon Co., Ltd.

At least one additive selected from the group consisting of heat stabilizers, mold release agents, antioxidants, impact modifiers, flame retardants and anti-drip agents is very particularly preferably present, in particular in an amount of 0% to 3% by weight. Mixtures of two or more of the aforementioned additives may also be present.

The compositions according to the invention are preferably free from optical brighteners.

It is exceptionally preferred when the compositions according to the invention contain at least one additive from the group consisting of heat stabilizers, flame retardant and impact modifiers. Additional additives from the group of further additives of component D may also be present but need not be.

As a further additive at least one anti-drip agent may be present, preferably in an amount of 0.05% by weight to 1.5% by weight, in particular 0.1% by weight to 1.0% by weight.

The production of the compositions according to the invention comprising components A to C and optionally D and optionally blend partners is effected by commonly used incorporation processes by combination, mixing and homogenization of the individual constituents, wherein in particular the homogenization preferably takes place in the melt under the influence of shear forces. Combination and mixing is optionally effected prior to melt homogenization using powder pre-mixes.

It is also possible to use premixes of pellets, or of pellets and powders, with components B, C and optionally D, with the polycarbonate or else with the optionally present blend partners.

It is also possible to use pre-mixes produced from solutions of the mixture components in suitable solvents where homogenization is optionally effected in solution and the solvent is then removed.

In particular, the components of the composition according to the invention may be introduced into the polycarbonate, optionally into the polycarbonate with blend partners, by known methods or as a masterbatch.

The use of masterbatches to incorporate the components B to D—individually or as mixtures—is preferable.

In this connection, the composition according to the invention can be combined, mixed, homogenized and subsequently extruded in customary apparatuses such as screw extruders (ZSK twin-screw extruders for example), kneaders or Brabender or Banbury mills. The extrudate may be cooled and comminuted after extrusion. It is also possible to premix individual components and then to add the remaining starting materials individually and/or likewise mixed.

The combining and mixing of a pre-mix in the melt may also be effected in the plasticizing unit of an injection molding machine. In this case, the melt is directly converted into a molded article in the subsequent step.

Thermoplastic compositions preferred according to the invention contain
A) 44.9% by weight to 95.996% by weight of aromatic polycarbonate,
B) 4.0% to 25% by weight of titanium dioxide and
C) 0.004% by weight to 0.1% by weight of glass flakes comprising a titanium dioxide coating, wherein the glass flakes comprising a titanium dioxide coating have a D50 value determined by scanning electron microscopy between 5 μm and 25 μm, an average aspect ratio determined by scanning electron microscopy between 1 and 5 and a thickness determined by scanning electron microscopy between 1 μm and 3 μm,
   wherein the reported amounts are in each case based on the total weight of the thermoplastic composition.

Thermoplastic compositions particularly preferred according to the invention consist of
A) 64.9% by weight to 95.996% by weight of aromatic polycarbonate,
B) 4.0% to 25% by weight of titanium dioxide and
C) 0.004% by weight to 0.1% by weight of glass flakes comprising a titanium dioxide coating, wherein the glass flakes comprising a titanium dioxide coating have a D50 value determined by scanning electron microscopy between 5 μm and 25 μm, an average aspect ratio determined by scanning electron microscopy between 2 and 3 and a thickness determined by scanning electron microscopy between 1.0 μm and 2 μm and wherein the average thickness of the titanium dioxide coating determined by scanning electron microscopy in conjunction with energy-dispersive X-ray spectrometry is 100 nm to 300 nm, in particular 120 nm to 200 nm,
D) 0% to 10% by weight of one or more further additives distinct from components B and C selected from the group consisting of heat stabilizers, flame retardants, antioxidants, mold release agents, anti-drip agents, UV absorbers, IR absorbers, impact modifiers, antistats, optical brighteners, fillers distinct from components B and C, light scattering agents, inorganic pigments distinct from component B, hydrolysis stabilizers, transesterification inhibitors, compatibilizers and/or additives for laser marking, wherein the reported amounts are in each case based on the total weight of the thermoplastic composition.

Very particularly preferred compositions according to the invention consist of
A) 76.99% by weight to 89.994% by weight of aromatic polycarbonate,
B) 10% to 13% by weight of titanium dioxide and
C) 0.006% by weight to 0.01% by weight of glass flakes comprising a titanium dioxide coating, wherein the glass flakes comprising a titanium dioxide coating have a D50 value determined by scanning electron microscopy between 5 μm and 25 μm, an average aspect ratio determined by scanning electron microscopy between 2 and 3 and a thickness determined by scanning electron microscopy between 1.0 μm and 2 μm and wherein the average thickness of the titanium dioxide coating determined by scanning electron microscopy in conjunction with energy-dispersive X-ray spectrometry is 100 nm to 300 nm, in particular 120 nm to 200 nm,
D) 0% to 10% by weight of one or more further additives distinct from components B and C selected from the group consisting of heat stabilizers, flame retardants, antioxidants, mold release agents, anti-drip agents, UV absorbers, IR absorbers, impact modifiers, antistats, optical brighteners, fillers distinct from components B and C, light scattering agents, inorganic pigments distinct from component B, hydrolysis stabilizers, transesterification inhibitors, compatibilizers and/or additives for laser marking, wherein the reported amounts are in each case based on the total weight of the thermoplastic composition.

The compositions according to the invention preferably have a melt volume flow rate (MVR) of 3 to 40 cm³/(10 min), more preferably of 6 to 30 cm³/(10 min), yet more preferably of 8 to 25 cm³/(10 min), particularly preferred 9 to 24 cm³/(10 min), determined according to ISO 1133:2012-3 (test temperature 300° C., mass 1.2 kg). The compositions according to the invention are preferably used for producing molded parts.

Production of the molded parts is preferably effected by injection molding, extrusion or from solution in a casting process. The compositions according to the invention can be processed in a customary manner in standard machines, for example in extruders or injection molding machines, to give any molded articles, for example films, sheets or bottles.

The compositions/molded parts made of the compositions appear “brilliant white” to the observer. The coated glass flakes show good compatibility with the polycarbonate matrix. This is apparent from the consistently high melt stability of the compounds.

The compositions according to the invention are suitable for producing multilayered systems. The polycarbonate-containing composition is applied in one or more layers to a molded article made of a plastic or itself serves as a substrate layer upon which one or more further layers are applied. Application may be carried out at the same time as or immediately after the molding of the molded article, for example by in-mold coating of a film, coextrusion or multicomponent injection molding. However, application can also take place onto the finished molded main body, for example by lamination with a film, insert molding of an existing molded article or by coating from a solution.

The compositions according to the invention are suitable for production of components in the lighting sector, for instance reflectors of lamps, in particular LED lamps or LED arrays, in the automotive sector, for instance headlight and taillight reflectors, of parts for indicators, trim pieces, switches or bezels and for producing bezels or bezel parts or housings or housing parts in the electricals and electronics and IT sectors. On account of the very good reflectance values the compositions according to the invention are preferably used for producing reflectors. These and other molded parts consisting of the compositions according to the invention or, for example in the case of multicomponent injection molding, comprising these, including moldings constituting a layer of a multilayered system or layers of multilayered systems or an element of an abovementioned component or such a component as a whole and made of (“consisting of”) these compositions according to the invention, likewise form part of the subject matter of the present application. The compositions according to the invention are also employable as a 3D printing material in the form of filaments, as pellets or powder.

The embodiments described hereinabove for the compositions according to the invention also pertain—if applicable—to the use according to the invention of component C, i.e. the use for improving reflectance.

The examples which follow are intended to illustrate the invention but without limiting said invention.

### EXAMPLES

### 1. Description of Raw Materials and Test Methods

The polycarbonate compositions described in the following examples were produced on a Berstorff ZE 25 extruder at a throughput of 10 kg/h by compounding. The melt temperature was 275° C.

Component A1: Linear polycarbonate based on bisphenol A having a melt volume-flow rate MVR of 19 cm³/(10 min) (according to ISO 1133:2012-03, at a test temperature of 300° C. and under a load of 1.2 kg). The product contains 250 ppm of triphenylphosphine as component D1.

Component A2: Linear polycarbonate based on bisphenol A in powder form having a melt volume-flow rate MVR of 19 cm³/(10 min) (according to ISO 1133:2012-03, at a test temperature of 300° C. and under a load of 1.2 kg).

Component B: Kronos 2230 titanium from Kronos Titan GmbH, Leverkusen.

Component C1: Metashine Microglass GT 1020RS glass flakes coated with titanium dioxide (rutile-type) from Nippon Sheet Glass Co., Ltd, D50 value: 6.2 μm Average aspect ratio: 2.31. The thickness of the glass flakes (without coating) is about 1.3 μm and the thickness of the titanium dioxide layer is 149 nm. The total thickness of the titanium dioxide-coated glass flakes is about 1.6 μm.

Component C2: Metashine Microglass GT 1080RS glass flakes coated with titanium dioxide (rutile-type) from Nippon Sheet Glass Co., Ltd, D50 value: 23.2 μm Average aspect ratio: 2.89. The thickness of the glass flakes (without coating) is about 1.6 μm and the thickness of the titanium dioxide layer is 164 nm. The total thickness of the titanium dioxide-coated glass flakes is about 1.9 μm.

Component D1: Triphenylphosphine, commercially available from BASF SE, Ludwigshafen.

Melt volume flow rate (MVR) was determined according to ISO 1133:2012-03 (at a testing temperature of 300° C., mass 1.2 kg) using a Zwick 4106 instrument from Zwick Roell. MVR was also measured after a preheating time of 20 minutes (IMVR20′). This is a measure of melt stability under elevated thermal stress.

Determination of ash content was carried out according to DIN 51903:2012-11 (850° C., hold for 30 min).

The total reflectance spectrum was measured on the basis of the standard ASTM E 1331-04 using a spectrophotometer. The total transmittance spectrum was measured on the basis of the standard ASTM E 1348-15 using a spectrophotometer.

The transmittance or reflectance spectrum thus obtained was used to calculate visual transmittance Ty (illuminant D65, observer 10°) or visual reflectance Ry (illuminant D65, observer 10°) in each case according to ASTM E 308-08. This also applies to the color values L*a*b*.

Shine was determined according to ASTM D 523-14 (2018).

Yellowness Index (Y.I.) was determined according to ASTM E 313-10 (Observer: 10°/illuminant: D65).

In the following table the inventive experiments are labelled “E” and the comparative examples are labelled “V”.

TABLE 1

| | | | Example | | | | | |
|---|---|---|---|---|---|---|---|---|
| | | | V-1 | E-2 | E-3 | E-4 | V-5 | V-6 |
| Component | | | % by wt | % by wt | % by wt | % by wt | % by wt | % by wt |
| A1 | | | 80.000 | 80.000 | 80.000 | 80.000 | 80.000 | 80.000 |
| A2 | | | 8.000 | 7.994 | 7.992 | 7.990 | 7.500 | 7.000 |
| B | | | 12.000 | 12.000 | 12.000 | 12.000 | 12.000 | 12.000 |
| C1 | | | | 0.006 | 0.008 | 0.010 | 0.500 | 1.000 |
| Test | Condition | Standard/unit | | | | | | |
| Ash content | 850° C./0.5 h | % | 11.92 | 11.99 | 12.02 | 11.92 | 12.41 | 12.73 |
| (average) | | | | | | | | |
| MVR | 300° C.; 1.20 kg; | cm³/[10 min] | 24.2 | 24.0 | 24.8 | 25.0 | 25.3 | 23.9 |
| | 7 min | | | | | | | |
| MVR | 300° C.; 1.20 kg; | cm³/[10 min] | 27.6 | 26.4 | 26.3 | 27.2 | 25.9 | 28.1 |
| | 20 min | | | | | | | |
| Delta | | | 3.4 | 2.4 | 1.5 | 2.2 | 0.6 | 4.2 |
| MVR/IMVR20′ | | | | | | | | |
| Test | Condition | | | | | | | |
| Transmittance | PELambda950, | | | | | | | |
| | Photometry | | | | | | | |
| | sphere 0°/ | | | | | | | |
| | diffuse; D65; | | | | | | | |
| | 10° | | | | | | | |
| Sample | | mm | 1 | 1 | 1 | 1 | 1 | 1 |
| thickness (ro) | | | | | | | | |
| L* (ro) | | ASTM E 308 | 3.16 | 3.57 | 3.8 | 4.04 | 2.89 | 2.28 |
| a* (ro) | | ASTM E 308 | 4.72 | 4.59 | 4.54 | 4.37 | 4.72 | 5.17 |
| b* (ro) | | ASTM E 308 | 16.24 | 16.2 | 16.25 | 16.27 | 16.11 | 15.9 |
| Transmittance | | [%] ASTM D | 0.45 | 0.48 | 0.5 | 0.52 | 0.43 | 0.39 |
| (ro) | | 1003/ISO 13468 | | | | | | |
| Reflectance | Hunter UltraS- | ASTM E 1331 | | | | | | |
| | canPRO, | with shine | | | | | | |
| | Diffuse/8°; D65; | | | | | | | |
| | 10° | | | | | | | |
| Sample | | mm | 2 | 2 | 2 | 2 | 2 | 2 |
| thickness (ro) | | | | | | | | |
| L* (ro) | | | 98.37 | 98.42 | 98.45 | 98.45 | 98.34 | 98.26 |
| a* (ro) | | | −0.62 | −0.62 | −0.62 | −0.62 | −0.61 | −0.61 |
| b* (ro) | | | 2.12 | 2.14 | 2.14 | 2.13 | 2.13 | 2.16 |
| Reflectance (ro) | | % | 95.83 | 95.96 | 96.04 | 96.04 | 95.77 | 95.58 |
| Yellowness | | | 3.46 | 3.47 | 3.49 | 3.46 | 3.48 | 3.54 |
| index (ro) | | | | | | | | |
| 60° Shine (ro) | | | 102 | 102 | 101 | 101 | 96 | 92 |

The addition of small amounts of glass flakes C1 results in a marked improvement in reflectance (E-2 to E-4 versus V-1). Flowability and gloss remain at the same level. Transmittance is slightly improved.

An amount of 0.5% by weight of component C1 has an opposite effect (V-5 and V-6): Reflectance is significantly impaired.

TABLE 2

| | | | Example | | | | | |
|---|---|---|---|---|---|---|---|---|
| | | | V-7 | E-8 | E-9 | E-10 | V-11 | V-12 |
| Component | | | % by wt | % by wt | % by wt | % by wt | % by wt | % by wt |
| A1 | | | 80.000 | 80.000 | 80.000 | 80.000 | 80.000 | 80.000 |
| A2 | | | 8.000 | 7.994 | 7.992 | 7.990 | 7.500 | 7.000 |
| B | | | 12.000 | 12.000 | 12.000 | 12.000 | 12.000 | 12.000 |
| C2 | | | | 0.006 | 0.008 | 0.010 | 0.500 | 1.000 |
| Test | Condition | Standard/unit | | | | | | |
| Ash content | 850° C./0.5 h | % | 11.96 | 12.04 | 11.72 | 11.76 | 12.38 | 12.74 |
| (average) | | | | | | | | |
| MVR | 300° C.; 1.20 kg; | cm³/[10 min] | 24.7 | 23.1 | 23.7 | 24.8 | 24.7 | 26.3 |
| | 7 min | | | | | | | |
| MVR | 300° C.; 1.20 kg; | cm³/[10 min] | 26.5 | 27 | 26.5 | 26.3 | 27.4 | 33.9 |
| Delta | 20 min | | 1.8 | 3.9 | 2.8 | 1.5 | 2.7 | 7.6 |
| MVR/IMVR20′ | | | | | | | | |
| Test | Condition | | | | | | | |
| Transmittance | PELambda950, | | | | | | | |
| | Photometry | | | | | | | |
| | sphere 0°/ | | | | | | | |
| | diffuse; D65; | | | | | | | |
| | 10° | | | | | | | |
| Sample | | mm | 1 | 1 | 1 | 1 | 1 | 1 |
| thickness (ro) | | | | | | | | |
| L* (ro) | | ASTM E 308 | 2.74 | 3.13 | 3.1 | 3.56 | 2.26 | 1.71 |
| a* (ro) | | ASTM E 308 | 4.86 | 4.7 | 4.68 | 4.66 | 5.12 | 5.37 |
| b* (ro) | | ASTM E 308 | 15.99 | 16.31 | 16.18 | 16.7 | 16.19 | 15.82 |
| Transmittance | | [%] ASTM D | 0.42 | 0.45 | 0.45 | 0.48 | 0.39 | 0.36 |
| (ro) | | 1003/ISO 13468 | | | | | | |
| Reflectance | Hunter UltraS- | ASTM E 1331 | | | | | | |
| | canPRO, | with shine | | | | | | |
| | Diffuse/8°; D65; | | | | | | | |
| | 10° | | | | | | | |
| Sample | | mm | 2 | 2 | 2 | 2 | 2 | 2 |
| thickness (ro) | | | | | | | | |
| L* (ro) | | | 98.31 | 98.37 | 98.39 | 98.4 | 98.26 | 98.14 |
| a* (ro) | | | −0.6 | −0.61 | −0.61 | −0.61 | −0.59 | −0.57 |
| b* (ro) | | | 2.07 | 2.12 | 2.12 | 2.14 | 2.13 | 2.17 |
| Reflectance (ro) | | % | 95.69 | 95.85 | 95.9 | 95.93 | 95.56 | 95.28 |
| Yellowness | | | 3.38 | 3.46 | 3.46 | 3.5 | 3.49 | 3.59 |
| index (ro) | | | | | | | | |
| 60° Shine (ro) | | | 100 | 100 | 100 | 100 | 97 | 93 |

The addition of small amounts of glass flakes C2 results in a marked improvement in reflectance (E-8 to E-10 versus V-7). However, a quantity of 0.5% by weight of the glass flakes already has the opposite effect (V-11 and V-12): Reflectance is significantly impaired.

TABLE 3

| | | | Example | | | | |
|---|---|---|---|---|---|---|---|
| | | | V-13 | E-14 | E-15 | E-16 | E-17 |
| Component | | | % by wt | % by wt | % by wt | % by wt | % by wt |
| A1 | | | 80.000 | 80.000 | 80.000 | 80.000 | 80.000 |
| A2 | | | 5.000 | 4.994 | 4.900 | 4.800 | 4.750 |
| B | | | 15.000 | 15.000 | 15.000 | 15.000 | 15.000 |
| C2 | | | | 0.006 | 0.100 | 0.200 | 0.250 |
| Test | Condition | Standard/unit | | | | | |
| Ash content | 850° C./0.5 h | % | 14.24 | 14.97 | 15.15 | 15.28 | 15.13 |
| (average) | | | | | | | |
| MVR | 300° C.; 1.20 kg; | cm³/[10 min] | 19.3 | 25 | 24.7 | 20.7 | 19.3 |
| | 7 min | | | | | | |
| MVR | 300° C.; 1.20 kg; | cm³/[10 min] | 19.9 | 28 | 25.4 | 24.1 | 19.7 |
| Delta | 20 min | | 0.6 | 3 | 0.7 | 3.4 | 0.4 |
| MVR/IMVR20′ | | | | | | | |
| Test | Condition | | | | | | |
| Transmittance | PELambda950, | | | | | | |
| | Photometry | | | | | | |
| | sphere 0°/ | | | | | | |
| | diffuse; D65; | | | | | | |
| | 10° | | | | | | |
| Sample | | mm | 1 | 1 | 1 | 1 | 1 |
| thickness (ro) | | | | | | | |
| L* (ro) | | ASTM E 308 | −2.46 | −1.28 | −0.56 | −0.22 | −0.86 |
| a* (ro) | | ASTM E 308 | 4.61 | 5.12 | 4.87 | 4.66 | 4.65 |
| b* (ro) | | ASTM E 308 | 11.44 | 13.99 | 13.91 | 13.58 | 12.5 |
| Transmittance | | [%] ASTM D | 0.16 | 0.2 | 0.24 | 0.25 | 0.22 |
| (ro) | | 1003/ISO 13468 | | | | | |
| Reflectance | Hunter UltraS- | ASTM E 1331 | | | | | |
| | canPRO, | with shine | | | | | |
| | Diffuse/8°; D65; | | | | | | |
| | 10° | | | | | | |
| Sample | | mm | 2 | 2 | 2 | 2 | 2 |
| thickness (ro) | | | | | | | |
| L* (ro) | | | 97.93 | 98.3 | 98.35 | 98.4 | 98.27 |
| a* (ro) | | | −0.57 | −0.62 | −0.62 | −0.63 | −0.58 |
| b* (ro) | | | 1.56 | 2 | 1.96 | 1.9 | 1.63 |
| Yellowness | | % | 94.74 | 95.68 | 95.80 | 95.91 | 95.58 |
| index (ro) | | | 2.46 | 3.22 | 3.15 | 3.04 | 2.57 |
| 60° Shine (ro) | | | 102 | 101 | 101 | 100 | 100 |

1. A thermoplastic composition, containing
A) 44% by weight to 96.999% by weight of aromatic polycarbonate,
B) 3.0% to 30.0% by weight of titanium dioxide, and
C) glass flakes comprising a titanium dioxide coating,
the amount of component C is 0.001% by weight to 0.25% by weight,
wherein the reported amounts are in each case based on the total weight of the thermoplastic composition.

2. The thermoplastic composition as claimed in claim 1, containing
A) 44.8% by weight to 95.996% by weight of aromatic polycarbonate,
B) 4.0% to 25% by weight of titanium dioxide, and
C) 0.004% by weight to 0.2% by weight of glass flakes comprising a titanium dioxide coating,
wherein the reported amounts are in each case based on the total weight of the thermoplastic composition.

3. The thermoplastic composition as claimed in claim 1, wherein the glass flakes comprising the titanium dioxide coating are shard-shaped.

4. The thermoplastic composition as claimed in claim 1, wherein titanium dioxide of the titanium dioxide coating of the glass flakes is of the rutile type.

5. The thermoplastic composition as claimed in claim 1, wherein the aromatic polycarbonate present is exclusively bisphenol A-based polycarbonate.

6. The thermoplastic composition as claimed in claim 1, consisting of
A) 64.8% by weight to 95.996% by weight of aromatic polycarbonate,
B) 4.0% to 25% by weight of titanium dioxide,
C) 0.004% by weight to 0.2% by weight of glass flakes comprising a titanium dioxide coating,
D) 0% to 10% by weight of one or more further additives(s) distinct from components B and C,
wherein the reported amounts are in each case based on the total weight of the thermoplastic composition.

7. The thermoplastic composition as claimed in claim 1, containing 0.006% to 0.010% by weight of component C.

8. The thermoplastic composition as claimed in claim 1, consisting of
A) 76.99% by weight to 94.994% by weight of aromatic polycarbonate,
B) 5% to 20% by weight of titanium dioxide,
C) 0.006% by weight to 0.010% by weight of glass flakes comprising a titanium dioxide coating,
D) 0% to 3% by weight of one or more further additives(s) distinct from components B and C,
wherein the reported amounts are in each case based on the total weight of the thermoplastic composition.

9. The thermoplastic composition as claimed in claim 1, wherein at least one additive from the group of heat stabilizers, flame retardants, impact modifiers and transesterification inhibitors is present in the composition as a further additive.

10. The thermoplastic composition as claimed in claim 1, wherein the glass flakes have a D50 value determined by scanning electron microscopy between 5 μm and 25 μm, an average aspect ratio determined by scanning electron microscopy between 1 and 5 and a thickness determined by scanning electron microscopy between 1 μm and 3 μm.

11. The thermoplastic composition as claimed in claim 1, wherein an average thickness of the titanium dioxide coating of the glass flakes determined by scanning electron microscopy in conjunction with energy dispersive X-ray spectrometry is between 50 nm and 400 nm.

12. A molded part made of a thermoplastic composition as claimed in claim 1.

13. The molded part as claimed in claim 12, wherein the molded part is a reflector or part of a reflector.

14. A method for improving reflectance of a titanium-dioxide-containing polycarbonate composition comprising including 0.001% by weight to 0.25% by weight, based on the total composition after addition of flakes, of the glass flakes comprising a titanium dioxide coating.

15. The method as claimed in claim 14, wherein the amount of glass flakes comprising the titanium dioxide coating is 0.006% to 0.010% by weight.
